(19) United States
(12) Patent Application Publication
(10) Pub. No.: US 2010/0277918 A1
(43) Pub. Date: Nov. 4, 2010

(54) LIGHT-EMITTING DIODE LIGHTING TUBE

(76) Inventors: CHIEN-YUAN CHEN, Taipei City (TW); Yi-Sheng Chen, Taipei City (TW)

Correspondence Address: LEONG C LEI, PMB # 1008, 1867 YGNACIO VALLEY ROAD, WALNUT CREEK, CA, 94598, US

(21) Appl. No.: 12/550,415

(22) Filed: Aug. 31, 2009

(30) Foreign Application Priority Data
Apr. 29, 2009 (TW) 098207200

(51) Int. Cl. F21S 4/00

(52) U.S. Cl. 362/249.02

(57) ABSTRACT

A light-emitting diode (LED) lighting tube is of a disassembleable structure, which arranges those components that are susceptible to easy damage in an end cap that is located at an outer side. Thus, when the lighting device is malfunctioning, it only needs to replace the end cap module that is located at the outer side to resume normal operation of the lighting tube. Parts of long lifespan of the lighting tube are preserved so that the costs are reduced and the tread of environmental protection is met.

### TECHNICAL FIELD OF THE INVENTION

The present invention generally relates to light-emitting diode (LED) lighting tube, and more particularly to an improved structure of an LED lighting tube that resembles the traditional fluorescent tube.

### DESCRIPTION OF THE PRIOR ART

The wide applications of white light-emitting diodes (LEDs) makes a breakthrough for lighting devices, where densely arranged white LEDs are used as a lighting source that provides sufficient brightness that is commonly realized through simultaneous use of a large number of high power LEDs. Since the number is great, the heat emission by the LEDs is also great, which often lead to high rate of malfunctioning of a power supply circuit arranged inside the lighting device, eventually shortening the lifespan of the LED lighting tube.

The known LED lighting tube often comprises a light-transmitting tube inside which a circuit board is arranged. The circuit board has a surface carrying a plurality of densely arranged LEDs and this surface of the circuit board functions as an illuminating surface of the lighting tube. The circuit board also has an opposite, back surface that carries the power supply circuit that is a must to the lighting tube and is composed of for example a starter, one or more capacitors, and other electronic components. The circuit board also comprises conductive terminals that extend beyond opposite ends of the lighting tube to engage a lighting tube holder.

The above discussed known device suffers certain drawbacks in the manufacture or use thereof, which are briefly discussed as follows:

(1) The circuit board is often arranged at an eccentric position inside the tube in order to provide a greater illuminating space. The eccentric arrangement of the circuit board shortens the distance between the back surface and the opposite inside surface of the tube, and this shortened distance prevents proper arrangement of the power supply circuit on the back surface. An alternative solution is to use a large-diameter lighting tube. This solution, however, prevents an LED lighting tube from down sizing by using a slenderer tube. This is generally due to improper arrangement of internal components of the lighting tube and this makes it difficult to improve the quality of the lighting tube. This is one of the major drawbacks that the conventional devices encounter.

(2) For the lighting tube to provide proper lighting effect, the LEDs arranged inside the tube must be of higher power. This substantially increases the heat generated by the LEDs, leading to a high rate of malfunctioning of the internal power supply circuit and also limiting the lifespan of the LED lighting tube.

(3) Malfunctioning of a LED lighting tube is often caused by the poor temperature resistance of the power supply circuit, and under such a condition, the LEDs are still working. This is a great waste of disposing of the LEDs, which is still of a substantial lifespan, with the whole device of the lighting tube due to a malfunctioning circuit board and this also increases the amount of garbage. Thus, the conventional LED lighting tube does not suit the trend of environmental conservation with the waste of the natural resources and increase of cost. This is another drawback of the conventional LED lighting tube.

The problems that the conventional LED lighting tube encounters, and the numerous drawbacks associated with manufacturing and use thereof, are generally due to improper arrangement of the internal components of the lighting tube. In view of such a problem, the present invention aims to provide a disassembleable lighting device, which arranges those components that are easily susceptible to damage at the outer side for easy replacement so as to reduce the manufacturing costs and the preserves sustainable use of long-lifespan parts that are arranged deeply inside the lighting device.

### SUMMARY OF THE INVENTION

The primary objective of the present invention is to provide a disassembleable light-emitting diode (LED) lighting device, which arranges parts that are easily susceptible to damage in an outside component, whereby when those parts are damaged, the outside component is removed and replaced to resume normal operation of the lighting device, and wherein parts having long lifespan are preserved for further use, so as to reduce the costs and meets the tread of environmental conservation.

To achieve the above objective, in accordance with the present invention, a solution is provided, comprising the following features:

A tube comprises a tubular body made of a light-transmitting material and having opposite ends.

A circuit board is mounted inside the tube and has a surface on which a plurality of light-emitting diodes (LEDs) is mounted in an array. The circuit board has opposite ends each forming two conductive terminals extending beyond a respectively end of the tube.

Two end caps are movably and respectively coupled to the ends of the tube.

A power supply circuit is arranged inside at least one of the end caps, the power supply circuit having an inner end forming a set of inner contacts and an outer end forming outer terminals that extend beyond the end cape to thereby form a lighting tube.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view, partly broken, of a lighting tube constructed in accordance with the present invention.

FIG. 2 is a cross-sectional view of the lighting tube of the present invention in an exploded form.

FIG. 3 is a cross-sectional view of the lighting tube of the present invention in an assembled form.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

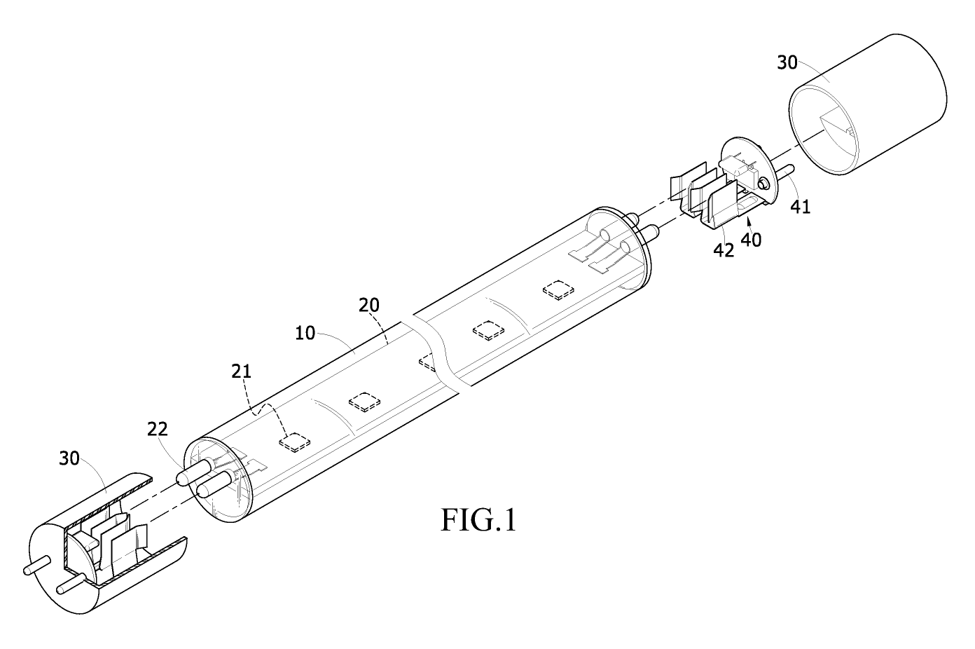

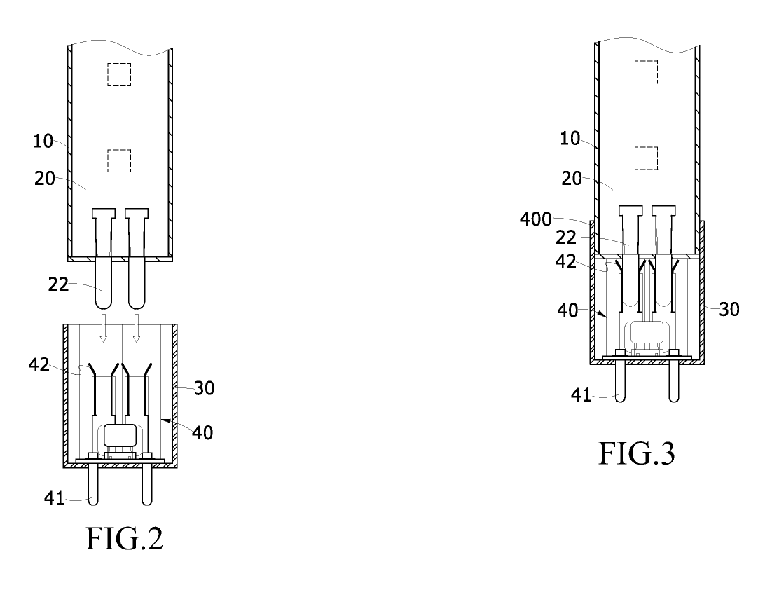

As shown in FIGS. 1 and 2, a lighting tube in accordance with the present invention comprises a tube (10), which is a tubular body made of a light-transmitting material and having opposite ends.

A circuit board (20) is mounted inside the tube (10) and has a surface on which a plurality of light-emitting diodes (LEDs) (21) is mounted in an array. The circuit board has opposite ends each forming two conductive terminals (22) extending beyond a respectively end of the tube (10).

Two end caps (30), which have a cross-section of a U-shaped, are movably and respectively coupled to the ends of the tube (10).

A power supply circuit (40) is arranged inside at least one of the end caps (30). The power supply circuit (40) has an inner end forming a set of inner contacts (42) respectively engageable with the two conductive terminals (22) of the corresponding end of the circuit board (20) and an outer end forming outer terminals (41) that extend beyond the end cape (30) to thereby form a lighting tube.

The coupling between the end caps (30) and the respective ends of the tube (10) can be realized through force fitting or rotary connection.

Referring to FIGS. 1-3, the tube (10) and the circuit board (20) that carries the LEDs (21) are tough parts that are not susceptible to easy damage. The power supply circuit (40), however, is a part that is easily susceptible to damage caused by temperature, humidity or undesired impact. When the power supply circuit (40) is damaged or broken, the end cap (30) that carries the damaged power supply circuit (40), together with the damaged power supply circuit (40), is removed from the end of the tube (10) for replacement of an end cap that carries a normal power supply circuit. This operation of replacement is easy and simple and the parts that are still normally functioning, especially the tube (10) and the circuit board (20) that carries the LEDs (21), which are more costly, can be preserved. Thus, cost of maintenance is reduced.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A light-emitting diode (LED) lighting tube, comprising:
a tube, which comprises a tubular body made of a light-transmitting material and having opposite ends;
a circuit board, which is mounted inside the tube and has a surface on which a plurality of light-emitting diodes is mounted in an array, the circuit board having opposite ends each forming two conductive terminals extending beyond a respectively end of the tube;
two end caps, which are movably and respectively coupled to the ends of the tube; and
a power supply circuit, which is arranged inside at least one of the end caps, the power supply circuit having an inner end forming a set of inner contacts and an outer end forming outer terminals that extend beyond the end cape to thereby form a lighting tube.

2. The LED lighting tube according to claim 1, wherein the end cap has a U-shaped cross-section.

3. The LED lighting tube according to claim 1, wherein the coupling between the end caps and the ends of the tube is force fitting.

4. The LED lighting tube according to claim 1, wherein the coupling between the end caps and the ends of the tube is rotary connection.
